(19) United States
(12) Patent Application Publication
(10) Pub. No.: US 2025/0324263 A1
(43) Pub. Date: Oct. 16, 2025

(54) TECHNIQUES FOR CONTROLLING ACCESS TO COMPUTING SYSTEMS BASED ON A RISK SCORE

(71) Applicant: EQUIFAX INC., Atlanta, GA (US)

(72) Inventors: Sukanksha Totade, Dunwoody, GA (US); Dilip Kumar Singh, Alpharetta, GA (US)

(21) Appl. No.: 19/175,584

(22) Filed: Apr. 10, 2025

Related U.S. Application Data
(60) Provisional application No. 63/634,134, filed on Apr. 15, 2024.

(51) Int. Cl. H04W 12/67; H04W 12/02; H04W 12/08

(52) U.S. Cl. CPC H04W 12/67; H04W 12/02; H04W 12/08

(57) ABSTRACT

A system can generate a risk indicator associated with a target entity. For example, the system can receive a request for a risk indicator associated with a target entity. For each data source in a set of data sources, the system can: retrieve identity data associated with the target entity based on the identity of the target entity; and generate a set of element risk scores and a set of affiliation scores associated with each element of the set of elements. The system can determine an aggregate element risk score and an aggregate element affiliation score. The system can determine the risk indicator by combining the aggregated element risk scores of the set of elements based on a first set of element weights. The system can transmit, to a remote computing device, a responsive message including at least the risk indicator.

### CROSS-REFERENCE TO RELATED APPLICATION

This application claims priority to U.S. Provisional Application No. 63/634,134, entitled “TECHNIQUES FOR CONTROLLING ACCESS TO COMPUTING SYSTEMS BASED ON A RISK SCORE,” filed on Apr. 15, 2024, the entire content of which is hereby incorporated by reference in its entirety.

### TECHNICAL FIELD

The present disclosure relates generally to controlling interactions between computing systems. More specifically, but not by way of limitation, this disclosure relates to controlling interactions between computing systems based on a risk score associated with a target entity and determined based on one or more parameters that can include personally identifiable information (PII).

### BACKGROUND

Various systems use binary identity verification to control access to restricted data or restricted computing environments. The output of a binary identity verification system can simply indicate whether an identity is or is not authenticated based on PII or credentials. But limited insights may be drawn from a binary verification output, for example with respect to risk. Additionally or alternatively, a binary verification output may not account for the intricacies of personally identifiable information (PII) and other risk factors. Binary assessment may not provide insights into how the output was generated and what factors the output was generated with, nor does a binary verification output capture a measure of risk associated with each element of an identity. This leads systems relying on such verification potentially vulnerable to bad actors using sophisticated methods to impersonate identities to gain access to restricted systems.

### SUMMARY

Various aspects of the present disclosure provide systems and methods for risk assessment. The system can receive a request for a risk indicator associated with a target entity, where the request includes a set of elements associated with an identity of the target entity. In some aspects, for each data source in a set of data sources, the system can: retrieve identity data associated with the target entity based on the identity of the target entity; and generate, based on the identity data, a set of element risk scores associated with each element of the set of elements, thereby creating a data source-level element risk score for each data source. For each element in the set of elements, the system can determine an aggregate element risk score by combining the data source-level element risk scores for the set of data sources, where the aggregate element risk score is based, in part, on a first set of data source weights associated with each respective data source. In some aspects, the system can further determine the risk indicator by combining the aggregated element risk scores of the set of elements based on a first set of element weights, where each element weight is associated with each respective element of the set of elements. The system can transmit, to a remote computing device, a responsive message including at least the risk indicator for use in controlling access of the target entity to one or more interactive computing environments.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of an operating environment in which a risk assessment computing system can be used to provide a risk indicator associated with a target entity according to some aspects of the present disclosure.

FIG. 2 is a block diagram depicting a system for generating a risk indicator associated with a target entity according to some aspects of the present disclosure.

FIG. 3 is a block diagram depicting an example of a risk assessment application for generating a risk indicator associated with a target entity according to some aspects of the present disclosure.

FIG. 4 is a flow chart illustrating a method for generating a risk indicator associated with a target entity according to some aspects of the present disclosure.

FIG. 5 is a block diagram depicting an example of a computing device, which can be used to implement the embodiments described herein according to some aspects of the present disclosure.

### DETAILED DESCRIPTION OF THE INVENTION

The present disclosure relates to controlling interactions between computing systems based on a risk score associated with a target entity. Disclosed systems and methods provide an advanced scoring model that solves at least the problem of binary assessment such as by providing a subtle scoring system. This approach provides a more nuanced understanding of risk by providing a multi-dimensional risk profile for a target entity based on risk attributes associated with PII elements, other suitable parameters, or any combination thereof. Additionally or alternatively, the explorable risk profile can recognize and categorize data based on its relevance and potential to indicate risk. By using a risk indicator to control access to secure resources, systems can maintain security and integrity, which can be used in authenticating entities such that a malicious actor is prevented from accessing secured systems. In some examples, the risk indicator can be used as a component in calculating an overall trust score for the target entity in which the trust score can be based at least in part on the risk indicator or at least in part on an affiliation score.

Controlling interactions between computing systems, such as providing access to a secure resource or computing environment, can be important to the security of such resources and computing environments. Interactions and access can be controlled based on risk assessments that can quantify the risk associated with a target entity. For example, a target entity can have an identity associated with a set of elements, such as a set of personally identifiable information (PII), which can include a name, address, phone number, Social Security Number (SSN), date of birth (DOB), and email address, etc. The values associated with each element of the set of PII can indicate an amount of risk based on a set of risk attributes associated with each element. Using these risk attributes, a risk score for each element can be determined that can indicate, for example, an amount of risk associated with the identity based on information associated with that element. A composite risk score can be generated by combining each element risk score to generate a risk score. The risk score can indicate an amount of risk associated with the target entity based on the target entity's PII or other suitable parameters associated with the target entity.

Certain aspects described herein for performing risk assessments on target entities using risk scores based on risk attributes associated with PII elements improve systems for controlling access to secure environments by providing a nuanced and explainable risk indicator. Generating a risk indicator associated with the target entity can provide a more comprehensive approach to risk assessment compared to conventional techniques that offer a binary output and do not account for how different PII elements, or other parameters associated with a target entity, contribute to the target entity's riskiness. For example, an explorable set of risk scores that facilitate more informed and accurate decisions, such as whether to allow a target entity to access a computing environment, can be provided. This can improve an entity's ability to prevent fraudulent activities and enhance data security in online environments and associated with online interactions. Unlike conventional techniques involving binary assessments, techniques described herein are robust and flexible, providing more metrics from which to base a risk assessment of a target entity. The risk indicator can reflect a level of risk associated with the target entity based on risk attributes associated with each PII element of the target entity. Provided PII can be used to determine an explorable and multi-faceted risk indicator that can be used to control access to secure resources, or that can be used as a component with which to determine a trust score for the target entity.

In some examples, a risk assessment computing system can receive a request for a risk indicator associated with a target entity. The request can include identity data associated with the target identity such that the identity data maps to PII elements. PII elements can include a name, an SSN, an address, a phone number, an email address, or a DOB, etc. The request can be received, for example, from an interactive computing environment as part of a process for authenticating the target entity to access the interactive computing environment. In some examples, the request can be received from a client computing system requesting a risk indicator for a monitored identity. In some aspects, the number and type of PII elements used to generate the risk indicator can be modified based on a desired level of security.

Using the identity data from the request, the system can retrieve a set of records matching the identity data. For example, the system can query one or more external data sources, such as external databases, to retrieve, from each data source, one or more records containing data matching the target entity's identity data. In some examples, the target entity may be associated with a name. The system can query a number of data sources to retrieve records including a name matching that of the target entity. Using the retrieved records and the information therein, the system can generate the risk attributes and risk indicator for the target entity.

To generate the risk indicator, the system may determine a risk score for each PII element associated with the target entity. For example, the system can generate a name risk score, an address risk score, an email address risk score, an SSN risk score, a DOB risk score, and a phone number risk score, etc. To generate each risk score, the system may generate values for a set of risk attributes associated with each element. The set of risk attributes can, for example, include various features associated with riskiness of the target entity in which the features can be determined from data associated with the target entity. Each risk attribute may be associated with an attribute weight. The attribute weight can reflect the strength with which a particular risk attribute contributes to the element risk score. Each individual element may be associated with an element weight. The element weight can reflect a degree to which the risk associated with the element contributes to the overall risk associated with the target entity. As an example, a name risk score may contribute more to the risk indicator than an address risk score because address risk may be less correlated with overall risk. Additionally or alternatively, the system may also generate a data source weight. The value of the data source weight can be based on, for example, a trustworthiness or accuracy of each data source. In some examples, a set of element weights can include a subset of weights associated with the identity of the target entity, and each weight of the subset of weights associated with the identity of the target entity can be determined based on an amount that the identity contributes the risk indicator based on a machine-learning model.

Using the weights, the system can construct a risk score, which can be a composite score that reflects a weighted combination of the element risk scores for each element, which can include each PII element. In some instances, the weights, such as the element weight, the attribute weight, and the data source weight, can be referred to as target variables. Each target variable of the target variables can be determined based on application of a separate machine-learning model to the records retrieved by the system using the target entity's identity data.

The system can generate a risk score, such as an element risk score, for each element at the data source level such as based on the weights. For the set of data sources, the system can generate an aggregate element risk score based on the data source-level element risk score for each data source and the data source weight associated with each data source. From the aggregate element risk score, the system can combine the aggregate element risk scores for the set of elements using the element weights to generate the overall risk score, or risk indicator, for the target entity.

The system can transmit the risk indicator to a remote computing system. In some examples, the remote computing system may be the system from which the risk indicator was requested. The risk indicator can be used to control access of the target entity to an interactive computing environment. For example, the risk indicator can be included in a responsive message to the request for evaluating the target entity such that the responsive message can be used to allow, challenge, or deny access to the target entity. For example, if the risk indicator is below a predefined threshold, a request by the target entity to access the interactive computing environment may be automatically granted. If the risk indicator is above a predefined threshold, which may indicate a high risk associated with the target entity, the request may be denied or flagged for manual or enhanced review. In some examples, the system can determine a trust indicator by combining a risk score and an affiliation score for the target entity, and the trust score can be used in combination with the risk indicator to generate the responsive message.

Certain aspects described herein, which can include generating one or more risk indicators associated with target entities and providing a responsive message using the risk indicator, can improve at least the technical fields of controlling interactions between computing environments, access control for a computing environment, data security, or a combination thereof. For instance, by generating and transmitting the responsive message, the risk assessment computing system can cause access to a computing system to be controlled more accurately. The risk indicator may be used to better predict whether the target entity requesting access is legitimate, and using the risk indicator may yield fewer malicious interactions than if the responsive message is not used, which can enhance data security and reduce instances of unauthorized disclosure of confidential or protected information. Further, the risk assessment computing system leverages distinctive components of the risk indicator to create a robust and easily implemented framework.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

Operating Environment Example for Generating a Risk Indicator Associated with a Target Entity

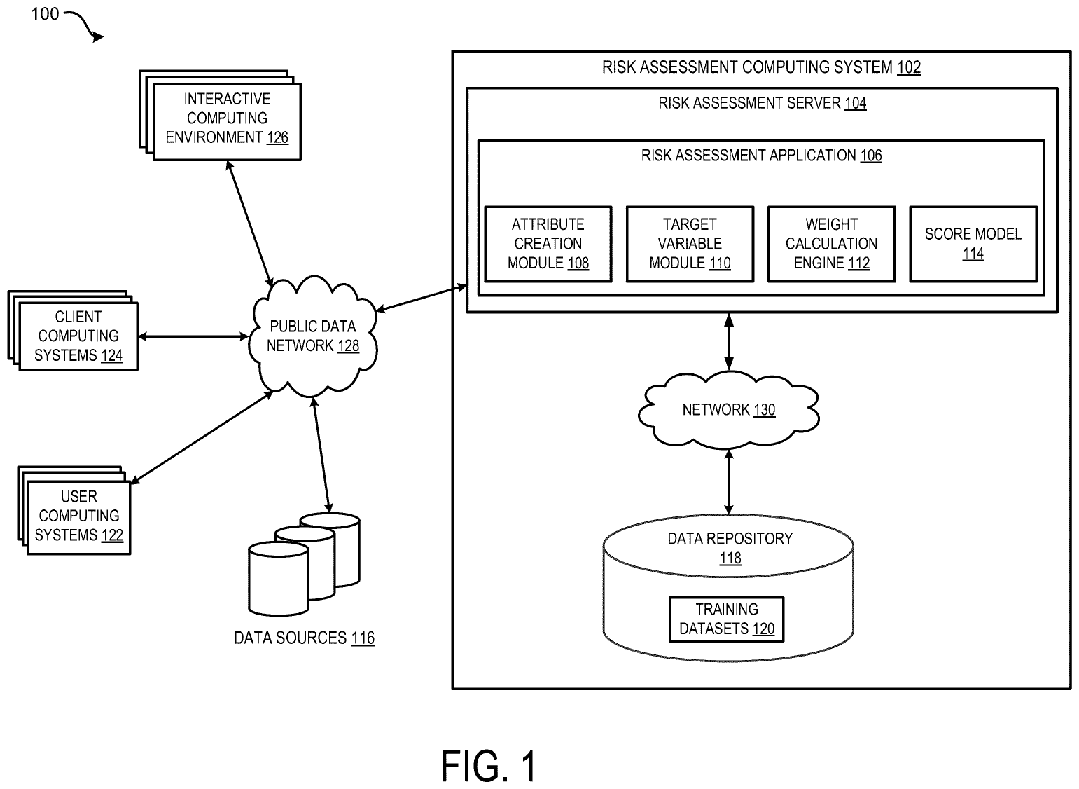

Referring now to the drawings, FIG. 1 is a block diagram depicting an example of an operating environment in which a risk assessment computing system can be used to provide a risk assessment associated with a target entity according to some aspects of the present disclosure. FIG. 1 depicts examples of hardware components of a risk assessment computing system 102 according to some aspects. The risk assessment computing system 102 can be a specialized computing system that may be used for processing large amounts of data using a large number of computer processing cycles. In other examples, the risk assessment computing system 102 may be or include a general-purpose computing system. The risk assessment computing system 102 can include a risk assessment server 104 for performing a risk assessment, such as predicting future risk associated with the target entity, predicting the legitimacy of the target entity, etc., with respect to a target entity such as a target individual or a user computing device.

The risk assessment server 104 can include one or more processing devices that can execute program code such as a risk assessment application 106. The program code can be stored on a non-transitory computer-readable medium or other suitable medium. The risk assessment application 106 can include one or more modules or components executing software code to complete one or more steps for determining a risk indicator. For example, the risk assessment application 106 can include: an attribute creation module 108; a target variable module 110; a weight calculation engine 112; and a score model 114, though other modules, engines, or models are possible for the risk assessment application 106. The attribute creation module 108 can create a set of risk attributes based on data associated with each PII element. The risk attributes can be passed to the target variable module 110, which may determine target variables, or weights, for each risk score component, such as attributes, elements, and data sources, that affect the risk score. The weight calculation engine 112 can determine the set of weights associated with each target variable, which can be used by the score model 114 for calculating the risk score.

The risk assessment server 104 can perform risk assessment operations or access control operations for validating or otherwise authenticating the target entity, for example using other suitable modules, models, components, etc. of the risk assessment server 104. The risk assessment server 104 can receive data associated with the target entity from external data sources 116, data repository 118, or any combination thereof. In some aspects, the risk assessment application 106 can authenticate or deny a request for an interaction involving the target entity by generating a risk indicator using the target entity data retrieved from the external data sources 116 and the data repository 118.

In some aspects, the target entity data can be determined or stored in one or more network-attached storage units on which various repositories, databases, or other structures are stored. An example of these data structures can include the data repository 118. Additionally or alternatively, training datasets 120 can be stored in the data repository 118. In some examples, the training datasets 120 can be used to train the machine-learning models associated with each weight of a set of weights that can include the element weight, the attribute weight, and the data source weight. Each machine-learning model can be trained to generate each respective weight that can be used for calculating the risk indicator. For example, to generate each weight, a binary output may be generated based on a set of rules and applied to a machine-learning model.

Network-attached storage units may store a variety of different types of data organized in a variety of different ways and from a variety of different sources. For example, the network-attached storage unit may include storage other than primary storage located within the risk assessment server 104 that is directly accessible by processors located therein. In some aspects, the network-attached storage unit may include secondary, tertiary, or auxiliary storage such as large hard drives, servers, and virtual memory, among other types of suitable storage. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

Furthermore, the risk assessment computing system 102 can communicate with various other computing systems. The other computing systems can include user computing systems 122, such as smartphones, personal computers, etc., client computing systems 124, and other suitable computing systems. For example, user computing systems 122 may transmit, such as in response to receiving input from the target entity, requests for accessing the interactive computing environment 126 to the client computing systems 124. In response, the client computing systems 124 can send authentication queries to the risk assessment server 104, and the risk assessment server 104 can receive data associated with the target entity used in the request and generate a risk indicator associated with the target entity. While FIG. 1 illustrates that the risk assessment computing system 102 and the client computing systems 124 are separate systems, the risk assessment computing system 102 and the client computing systems 124 can be one system. For example, the risk assessment computing system 102 can be a part of the client computing systems 124, or vice versa.

As illustrated in FIG. 1, the risk assessment computing system 102 may interact with the client computing systems 124, the user computing systems 122, or a combination thereof via one or more public data networks 128 to facilitate interactions between users of the user computing systems 122 and the interactive computing environment 126. For example, the risk assessment computing system 102 can facilitate the client computing systems 124 providing a user interface to the user computing system 122 for receiving various data from the user. The risk assessment computing system 102 can transmit validated risk assessment data, for example similarity-preserving hashes, comparisons or scores determined therefrom, etc., to the client computing systems 124 for providing, challenging, or rejecting, etc. access of the target entity to the interactive computing environment 126. In some examples, the risk assessment computing system 102 can additionally communicate with third-party systems to receive risk assessment data, entity data, and the like, through the public data network 128. In some examples, the third-party systems can provide real-time, such as streamed, data about the target entity, historical data about the target entity, etc., to the risk assessment computing system 102.

Each client computing system 124 may include one or more devices such as individual servers or groups of servers operating in a distributed manner. A client computing system 124 can include any computing device or group of computing devices operated by a seller, lender, or other suitable entity that can provide products or services. The client computing system 124 can include one or more server devices. The one or more server devices can include or can otherwise access one or more non-transitory computer-readable media.

The client computing system 124 can further include one or more processing devices that can be capable of providing an interactive computing environment 126, such as a user interface, etc., that can perform various operations. The interactive computing environment 126 can include executable instructions stored in one or more non-transitory computer-readable media. The instructions providing the interactive computing environment 126 can configure one or more processing devices to perform the various operations. In some aspects, the executable instructions for the interactive computing environment 126 can include instructions that provide one or more graphical interfaces. The graphical interfaces can be used by a user computing system 122 to access various functions of the interactive computing environment 126. For instance, the interactive computing environment 126 may transmit data to and receive data, such as via the graphical interface, from a user computing system 122 to shift between different states of the interactive computing environment 126 in which the different states allow one or more electronic interactions between the user computing system 122 and the client computing system 124 to be performed.

In some examples, the client computing system 124 may include other computing resources associated therewith, such as server computers hosting and managing virtual machine instances for providing cloud computing services, server computers hosting and managing online storage resources for users, server computers for providing database services, and others. The interaction between the user computing system 122, the client computing system 124, and the risk assessment computing system 102, or any suitable sub-combination thereof may be performed through graphical user interfaces, such as the user interface, presented by the risk assessment computing system 102, the client computing system 124, other suitable computing systems of the computing environment 100, or any suitable combination thereof. The graphical user interfaces can be presented to the user computing system 122. Application programming interface (API) calls, web service calls, or other suitable techniques can be used to facilitate interaction between any suitable combination or sub-combination of the client computing system 124, the user computing system 122, and the risk assessment computing system 102.

A user computing system 122 can include any computing device or other communication device that can be operated by a user or entity, such as the user entity, which may include a consumer or a customer. The user computing system 122 can include one or more computing devices such as laptops, smartphones, and other personal computing devices. A user computing system 122 can include executable instructions stored in one or more non-transitory computer-readable media. The user computing system 122 can additionally include one or more processing devices configured to execute program code to perform various operations. In various examples, the user computing system 122 can allow a user to access certain online services or other suitable products, services, or computing resources from a target entity, such as the client computing system 124, to engage in mobile commerce with the client computing system 124, to obtain controlled access to electronic content, such as the interactive computing environment 126, hosted by the client computing system 124, etc.

In some examples, the user or a target entity can use the user computing system 122 to engage in an electronic interaction with the client computing system 124 via the interactive computing environment 126. The risk assessment computing system 102 can receive a request, for example from the user computing system 122, to access the interactive computing environment 126 and can use target entity data or any other suitable data or signals determined therefrom, to determine whether to provide access, to challenge the request, to deny the request, etc. An electronic interaction between the user computing system 122 and the client computing system 124 can include, for example, the user computing system 122 being used to request a financial loan or other suitable services or products from the client computing system 124, and so on. An electronic interaction between the user computing system 122 and the client computing system 124 can also include, for example, one or more queries for a set of sensitive or otherwise controlled data, accessing online financial services provided via the interactive computing environment 126, submitting an online credit card application or other digital application to the client computing system 124 via the interactive computing environment 126, operating an electronic tool, such as a content-modification feature, an application-processing feature, etc., within the interactive computing environment 126, etc.

In some aspects, an interactive computing environment 126 implemented through the client computing system 124 can be used to provide access to various online functions. As a simplified example, a user interface or other interactive computing environment 126 provided by the client computing system 124 can include electronic functions for requesting computing resources, online storage resources, network resources, database resources, or other types of resources. In some examples, a website or other interactive computing environment 126 provided by the client computing system 124 can include electronic functions for obtaining one or more financial services, such as an asset report, management tools, credit card application and transaction management workflows, electronic fund transfers, etc.

A user computing system 122 can be used to request access to the interactive computing environment 126 provided by the client computing system 124. The client computing system 124 can submit a request, such as in response to a request made by the user computing system 122 to access the interactive computing environment 126, for risk assessment to the risk assessment computing system 102 and can selectively grant or deny access to various electronic functions based on risk assessment performed by the risk assessment computing system 102. Based on the request, or continuously or substantially contemporaneously, the risk assessment computing system 102 can determine one or more risk signals or risk indicators for data associated with the target entity, which may submit or may have submitted the request via the user computing system 122. Based on a risk indicator determined from the score model 114, the risk assessment computing system 102, the client computing system 124, or a combination thereof can determine whether to grant the access request of the user computing system 122 to certain features of the interactive computing environment 126. The risk assessment computing system 102, the client computing system 124, or a combination thereof can use the risk indicator for other suitable purposes such as identifying a manipulated identity, controlling a real-world interaction, and the like.

In a simplified example, the system illustrated in FIG. 1 can configure the risk assessment server 104 to be used for controlling access to the interactive computing environment 126. The risk assessment server 104 can retrieve data associated with the target entity in response to a request to access the interactive computing environment 126. The data may, for example, be retrieved based on identity information, such as information collected by the client computing system 124 via a user interface provided to the user computing system 122, provided by the client computing system 124 or received via other suitable computing systems. The risk assessment server 104 can retrieve the data associated with the target entity from one or more data sources 116. The data sources 116 can store, for example, historical data, transaction data, financial data, and the like. The risk assessment server 104 can determine a risk score associated with the target entity by generating a set of element risk scores and combining the element risk scores according to a first set of predefined weights. The risk assessment server 104 can transmit the risk score, or any inference derived therefrom, to the client computing system 124 for use in controlling access to the interactive computing environment 126.

The risk indicator associated with the target entity, or any suitable score or comparison determined therefrom, can be used, for example by the risk assessment computing system 102, the client computing system 124, etc., to determine whether the risk associated with the target entity accessing a good or a service provided by the client computing system 124 using is below a threshold, thereby granting, challenging, or denying access by the target entity to the interactive computing environment 126. For example, if the risk assessment computing system 102 determines that the risk indicator indicates that an amount of risk associated with the identity element is lower than a threshold value, then the client computing system 124 associated with the service provider can generate or otherwise provide access permission to the user computing system 122 that requested the access. The access permission can include, for example, cryptographic keys used to generate valid access credentials or decryption keys used to decrypt access credentials. The client computing system 124 can also allocate resources to the target entity and provide a dedicated web address for the allocated resources to the user computing system 122, for example, by adding the user computing system 122 in the access permission. With the obtained access credentials or the dedicated web address, the user computing system 122 can establish a secure network connection to the interactive computing environment 126 hosted by the client computing system 124 and access the resources via invoking API calls, web service calls, HTTP requests, other suitable mechanisms or techniques, etc.

In some examples, the risk assessment computing system 102 may determine whether to grant, challenge, or deny the access request made by the user computing system 122 for accessing the interactive computing environment 126. For example, based on the risk indicator associated with the target entity, the risk assessment computing system 102 can determine that the target entity is a legitimate entity that made the access request and may authenticate the request. In other examples, the risk assessment computing system 102 can challenge or deny the access attempt if the risk assessment computing system 102 determines that the target entity may not be a legitimate entity or may be associated with an unacceptable level of risk.

In some examples, the risk score may be determined at least in part based on output from one or more machine-learning models. For example, each type of weight, which may include the element weight, the attribute weight, the data source weight, etc., can be generated based on an application of a machine-learning model associated with the weight to a binary output based on the retrieved data associated with the target entity. The binary output can be generated, for example, by applying a set of one or more rules or logic to the retrieved data, as will be described in further detail below. Based on the weights, the element risk scores and data source-level element risk scores can be combined to generate the risk score.

Each communication within the computing environment 100 may occur over one or more data networks, such as a public data network 128, a network 130 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices illustrated in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate may be instead implemented in a signal device or system.

Architecture for Implementing a System for Generating a Risk Indicator Associated with a Target Entity

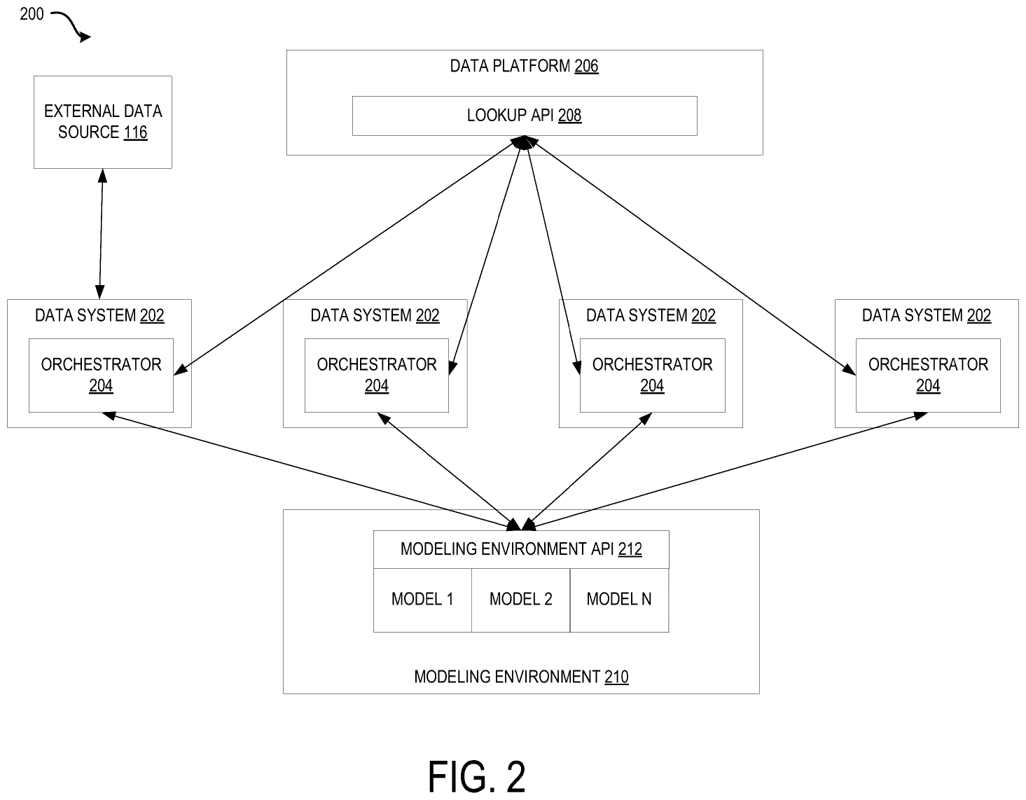

FIG. 2 is a block diagram depicting an example of an environment 200 for generating a risk assessment associated with a target entity according to some aspects of the present disclosure. The environment 200 can include components as described above with reference to FIG. 1. For example, the orchestrators 204 described with reference to FIG. 2 can be provided by or by part of the risk assessment computing system 102. Other implementations or architectures, however, are possible.

The environment 200 can include one or more data systems 202. Each data system 202 can be, for example, a product or system associated with the risk assessment computing system 102 or a client computing system 124. Each data system 202 may manage or otherwise control an external data source 116, or may have access to data stored by a data platform 206. For example, the data platform 206 can be associated with the risk assessment computing system 102. The data platform 206 can be separate from or can include the data repository 118. The data platform 206 may manage data associated with a set of entities. For example, the data platform 206 can manage data sources storing entity data, such as identity information or PII elements such as name, DOB, SSN, phone number, email address, address, etc. The data sources may store additional information, such as financial information, associated with each entity. In some examples, the data sources can store one or more risk attributes based on data associated with identities stored in the data sources. Risk attributes can, for example, quantify or otherwise indicate a level of risk based on a data feature. For example, a risk attribute can be a number of identities associated with an address of the target entity, or an age of a phone number associated with the target entity.

Each data system 202 can function independently from each other and from the risk assessment computing system 102. In some aspects, each data system 202 may be provided with an orchestrator 204. The orchestrator 204 can enable the data system 202 to retrieve data from the data platform 206 via a lookup API 208 of the data platform. The retrieved data can be associated with a target entity as part of a request for a risk assessment associated with the target entity. In some aspects, the orchestrator 204 can pull data associated with a target entity from data sources managed by the data platform 206. Certain data systems, such as the data systems 202, can be associated with one or more external data sources 116 and may receive data directly from the external data source 116.

The orchestrator 204 can then transmit the received data associated with the target entity, via a modeling environment API 212, to a modeling environment 210. The modeling environment 210 can generate the weights, such as the element weight, the attribute weight, the data source weight, or any combination thereof, used to generate the risk score for the target entity. In some aspects, each weight may be determined using a machine-learning model, such as Model 1, Model 2, . . . . Model N, in which the number of models corresponds to the number of weights used to generate the risk score. Similarly, the modeling environment 210 can also be configured to generate an additional set of weights used to generate the affiliation score associated with the target entity.

In some aspects, the modeling environment 210 can be a component of the risk assessment computing system 102. For example, the risk assessment application 106 can include or interact with the modeling environment 210 to receive the calculated weights and generate the risk score.

Exemplary Application for Generating a Risk Score Associated with a Target Entity

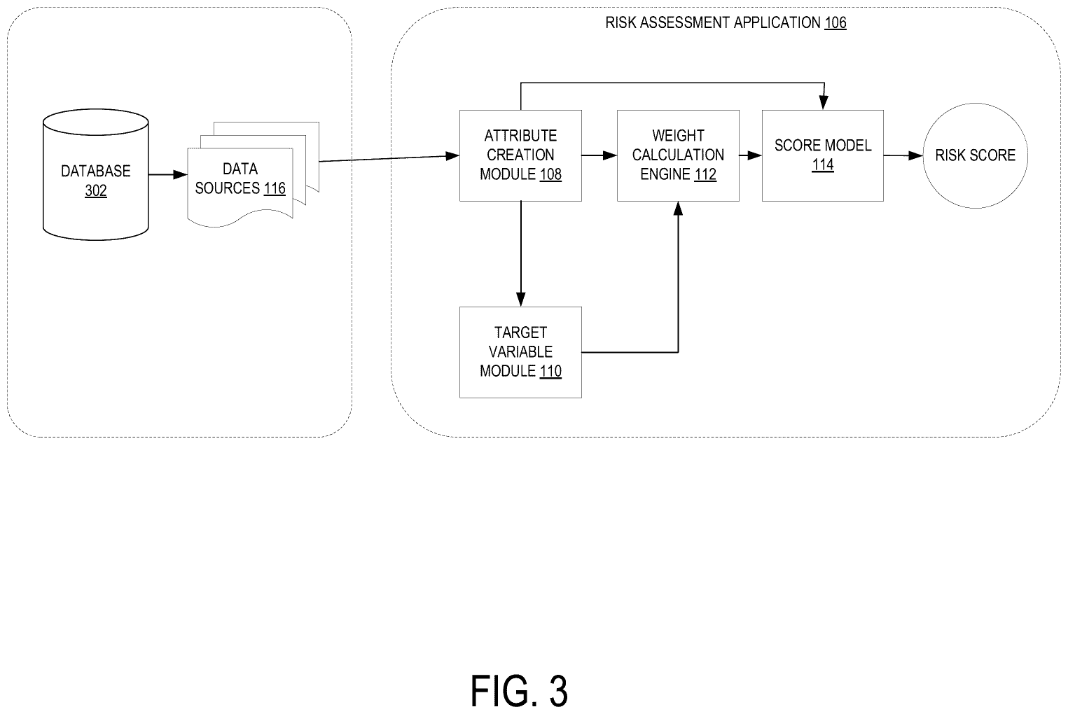

FIG. 3 is a block diagram depicting an example of the risk assessment application 106 for generating a risk assessment associated with a target entity according to some aspects of the present disclosure. As discussed with reference to FIG. 1, the risk assessment application 106 can be stored on a risk assessment server 104 and can be used by the risk assessment computing system 102 to generate risk indicators for target entities in response to requests from the client computing systems 124 or the user computing systems 122. Other implementations or architectures, however, are possible.

As discussed with reference to FIG. 1, the risk assessment application 106 can include an attribute creation module 108, a target variable module 110, a weight calculation engine 112, a score model 114, or any combination thereof. In response to receiving a request for a risk assessment of a target entity, the risk assessment application 106 can receive data associated with the target entity from external data sources 116. For example, the risk assessment application 106 can generate a query or request for data associated with the target entity and communicate that request to a data system, such as the data system 202, in communication with an external database or data platform 206. In some examples, the external data sources 116 may be populated by a database 302 storing a master dataset. As discussed above, each data system 202 can manage or access a portion of the master dataset.

The attribute creation module 108 can receive the data associated with the target entity and generate a set of risk attributes associated with each element. Each risk attribute can, for example, represent a feature associated with a degree of risk. Some examples of the risk attributes are listed in Table 1, which is produced below.

TABLE 1

| Element | Attribute |
|---|---|
| Phone | VOIP Risk |
| | Consumer/Commercial Phone |
| | Phone not allowed for consumers |
| | Phone Toll Free |
| | Phone porting |
| | Account Tenure |
| | Phone Disconnected |
| | Phone Not Active |
| | Phone Risk (Fraud Risk) |
| | # of Names linked to the phone |
| | # of SSNs linked to the phone |
| | # of Addresses linked to the phone |
| Email | Email Age |
| | Decline |
| | Omniscore |
| | Potentially Breached Email |
| | Synthetic ID Associated |
| | Email on Alert List |
| | Disposable Email |
| | Auto-generated Non-corporate Email |
| | Corporate Domain |
| | Usage Score |
| | Email Risk (Fraud Risk) |
| | # of Names linked to the email |
| | # of SSNs linked to the email |
| | # of Addresses linked to the email |
| SSN | ID Number |
| | Length |
| | Golden Social |
| | Not Golden Social |
| | Out of Range |
| | Access to the Golden Social Table |
| | Search Score |
| | Deceased |
| | Minor |
| | Verified |
| | SSN Affirm Alert |
| | Number of Addresses/Emails/Phones |
| | associated with SSN |
| | # of Names linked to the SSN |
| | # of Phones linked to the SSN |
| | # of Addresses linked to the SSN |
| Address | Multi-Dwelling Flag |
| | Address is commercial mail drop or general |
| | delivery |
| | Address is PO Box |
| | Address is correctional facility |
| | Prison Address |
| | # of Names linked to the address |
| | # of SSNs linked to the address |
| | # of phones linked to the address |

In some examples, the attribute creation module 108 can determine values for the attributes for each element or any subset thereof. Attribute values can be, for example, numerical values or a binary indicator such as True or False.

In some examples, various techniques can be used to determine a match for an element. For example, the attribute creation module 108 can use exact or fuzzy matching to determine if an address is a prison address or if an email appears of a list of breached or compromised email addresses. An exact match can refer to an instance in which identity information of the target entity exactly matches data from the data source. For example, a name or an address found exactly in data from the data source is an exact match. A fuzzy match can refer to an instance in which the identity data associated with the target entity matches data from the data source within a predetermined threshold. For example, to determine a fuzzy match, the attribute creation module 108 can use a string comparison function, such as the Jaro-Winkler distance or the Levenshtein distance. If the distance is below a predetermined threshold, the data from the data source can be considered a match for the identity data.

The attribute creation module 108 can determine, for each risk attribute associated with an element, the attribute values based on data from each data source. This information can then be passed to the target variable module 110. In some examples, the risk attribute value can be retrieved from each data source. The target variable module 110 can create target variables, which quantify the importance of each component that will be factored into the risk score. For example, components can include: PII element (e.g., a target variable based on the type of PII element); attribute (e.g., a target variable based on each attribute's ability to predict risk); and data source (e.g., a target variable based on metrics associated with each particular data source). Each target variable, or any subset, can be generated using a set of rules to generate a binary output for the particular target variable.

A set of weights can be generated for use in calculating the risk score. The weights can be generated by the weight calculation engine 112 using the sets of binary output generated by the target variable module 110. The weight calculation engine can apply the binary output of each target variable to a model associated with that weight or target variable. The binary output can be generated by applying a set of one or more rules to the retrieved data. A rule can indicate, for example, if data from a particular data source contains a PII element or a risk attribute. The set of rules can be or include, for example:

if (risk_attribute_1_name in Data Source 1) or
if (risk_attribute_2_name in Data Source 1) or ...
then 1
or
if (risk_attribute_1_name in Data Source 2) or
if (risk_attribute_2_name in Data Source 2) or...
then 1
...
else 0

In some aspects, the model can be a linear regression model as given by Equation 1:

$$y = {w}_{0} + {w}_{1} {x}_{1} + {w}_{2} {x}_{2} + … + {w}_{p} {x}_{p} \qquad Equation 1$$

in which y is the target variable, xₚ represents the “features” in which there are p features in the target variable, and wₚ represents the weights. In some examples, models or functions can be used to determine the weights of each target variable. For example, a SHAP package can be used in XGBoost or other machine-learning platform to use Shapley values to accurately estimate the contribution of each component, such as data source, association, match type, and element, etc., to the risk indicator.

The calculated weights can be passed to the score model 114 to be used in calculating the risk score. In some examples, in calculating each weight, the weight calculation engine 112 can perform cross-validation to ensure the weights are accurate, stable, and indicative of the contribution to the risk indicator of each represented component, which can include data source, attribute, and element.

The score model 114 can receive attributes from the attribute creation module 108 and weights from the weight calculation engine 112 and can use the attributes and weights, such as the respective element weights and attribute weights, to calculate the risk score for the target entity. The score model 114 can create element risk scores at the data source level based on the set of attributes associated with the element. As an example, the address risk score for a first data source can be determined using Equation 2:

$$name\_risk \_score \_data \_source \_ 1 = ( distinct\_names \_on \_address \_DS 1 * attribute weight 1 + prison\_address \_DS 1 * attribute weight 2 + … ) \qquad Equation 2$$

The score model 114 can repeat the above algorithm for each element in each data source. The element risk score for each data source can then be combined to create an aggregate element risk score for each element. As an example, an aggregated name risk score can be determined by using Equation 3:

$$aggregated\_name \_score = normalize ( name\_risk \_score \_data \_source \_ 1 * data\_source \_ 1 \_weight + name\_risk \_score \_data \_source \_ 2 * data\_source \_ 2 \_weight + … + name\_risk \_score \_data \_source \_n * data\_source \_n \_weight ) \qquad Equation 3$$

The above algorithm can be used to generate an aggregated element risk score for each element such as for name, for address, for DOB, for phone number, for email address, and for SSN, etc. The aggregated element risk score can be used to determine a final element risk score. As an example, the final name risk score can be determined using Equation 4:

$$name\_risk \_score = normalize ( aggregated\_name \_risk \_score + ( number of data sources affiliating / n ) + ( type of data source / t ) * 100 \qquad Equation 4$$

in which number of data sources affiliating refers to the number of data sources in which a match for name is found, n is the number of data sources, type of data source refers to the type of data source, for example internal or external, and t is the number of types of data sources such as two or another cardinal number. The output of the above equation for name_risk_score can include a score value ranging from 0 to 1 in which 1 indicates a high level of risk.

The score model 114 can determine the risk score using Equation 5:

$$risk score = normalized ( name\_risk \_score * name\_weight + address\_risk \text{} \_score * address\_weight + phone\_risk \_score * phone\_weight + email\_risk \_score * email\_weight + DOB\_risk \_score * DOB\_weight + SSN\_risk \_score * SSN\_weight ) \qquad Equation 5$$

Although shown here for six PII elements, the risk score can be calculated using any other suitable number, such as more than six or less than six, of elements and corresponding element weights.

The risk score, or risk indicator, can be transmitted to the requesting computing system and can be used in controlling access to a secure resource or system by the target entity. The risk indicator can be a composite risk score, where each element risk score is determined based on each associated risk attribute's predictive strength.

In some aspects, the calculated risk score can be combined with an affiliation score for the target entity to create a trust indicator. The trust indicator can be transmitted to a remote device, such as the client computing system 124 or the user computing systems 122, for use in controlling access of the target entity to the interactive computing environment 126. For example, a trust indicator having a high value can indicate a high level of trust associated with the target entity. A trust indicator having a low value can indicate the target entity has a relatively low level of trust. The trust indicator can be used to make decisions to allow or deny the target entity to access the interactive computing environment 126.

Techniques for Generating a Risk Indicator Associated with a Target Entity

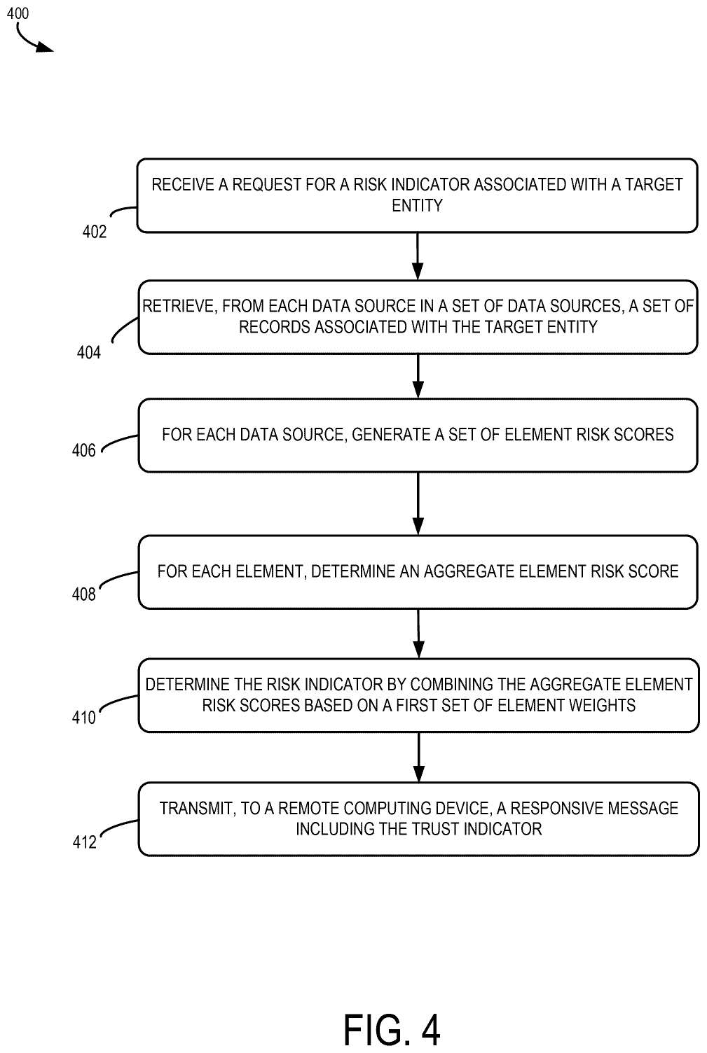

FIG. 4 is a flow chart illustrating an example of a process 400 for generating a risk assessment associated with a target entity according to some aspects of the present disclosure. In some examples, the operations of the process 400, or any subset thereof, may be performed by the risk assessment computing system 102 via the risk assessment server 104, but other suitable systems, devices, or subsets or combinations thereof may perform one or more operations described with respect to the process 400. For illustrative purposes, the process 400 is described with reference to certain examples depicted in the figures. Other implementations, however, are possible.

At block 402, the process 400 involves receiving a request for a risk indicator associated with a target entity. The request can include a set of elements associated with an identity of the target entity. The elements can be or include, for example, a name, address, SSN, DOB, phone number, or email address. The request may be generated as part of an authentication process initiated when the target entity attempts to access an interactive computing environment 126.

At block 404, the process 400 involves retrieving, for each data source, identity data associated with the target entity based on the identity of the target entity. For example, the risk assessment application 106 can generate a query based on the received identity information to query a set of data sources, such as the data sources 116, to retrieve identity data associated with the target entity. As discussed above, the records can be retrieved using an orchestrator 204 loaded on a data system 202 such as a product managed by the risk assessment computing system 102. The retrieved identity data can be used to generate values for risk attributes associated with each element.

In some examples, using the weight calculation engine 112, the risk assessment application 106 can determine a first set of weights including a data source weight, an attribute weight, and an element weight. For example, the data source weight can be based on a number of elements of the set of elements that are present in the set of records associated with each data source. The attribute weight can be based on an attribute's contribution to the data source-level element risk score.

At block 406, the process 400 involves generating, based on the identity data, a set of element risk scores associated with each element of the set of elements thereby creating a data source-level element risk score for each data source and each element. The data source-level element risk score can be based at least in part on the attribute weights for each risk attribute associated with the element.

At block 408, the process 400 involves determining, for each element, an aggregate element risk score by combining the data source-level element risk scores for the set of data sources. In some examples, the aggregate element risk score can be based at least in part on a first set of data source weights associated with each respective data source. For example, data sources including more elements matching those of the target entity may be weighted more heavily than data sources containing fewer elements matching those of the target entity. Additionally or alternatively, the first set data source weights may be generated based on a relative trustworthiness of the data source or on an average accuracy of the data contained in the data source. In some examples, the aggregated element risk scores can be normalized across the number and type of data sources in the set of data sources to generate a normalized aggregate element risk score ranging from 0 to 1.

At block 410, the process 400 involves determining the risk indicator by combining the aggregated element risk scores of the set of elements based on a first set of element weights. The element weights can indicate, for example, a degree with which the risk associated with a particular element is representative of risk associated with the target entity. For example, an SSN may have a relatively high weight, while an address that a number of entities have resided at may have a lower weight as it is less determinative of risk. The score model 114 can generate the risk score by combining the elements by weight.

At block 412, the process 400 involves transmitting, to a remote computing device, a responsive message comprising at least the risk indicator for use in controlling access of the target entity to one or more interactive computing environments. For example, the risk indicator can be used in controlling an interaction involving a target entity or access of the target entity to a restricted system.

Systems and methods described herein provide advantages over traditional, binary identity verification systems. For example, rather than binary identity verification, disclosed systems and methods provide a measure of risk associated with an identity based on provided PII. In some examples, the risk assessment computing system 102 can provide an explorable risk indicator, allowing a user to review each element's contribution, or each risk attribute's contribution, to the risk indicator. Additionally or alternatively, by incorporating data from a set of data sources, the risk assessment computing system 102 can generate a more accurate and dependable risk indicator. Further, by weighting the contribution of each data source, the risk assessment computing system 102 can generate a risk indicator that account, for example, for variations in the trustworthiness and accuracy of the data sources.

### Example of Computing System

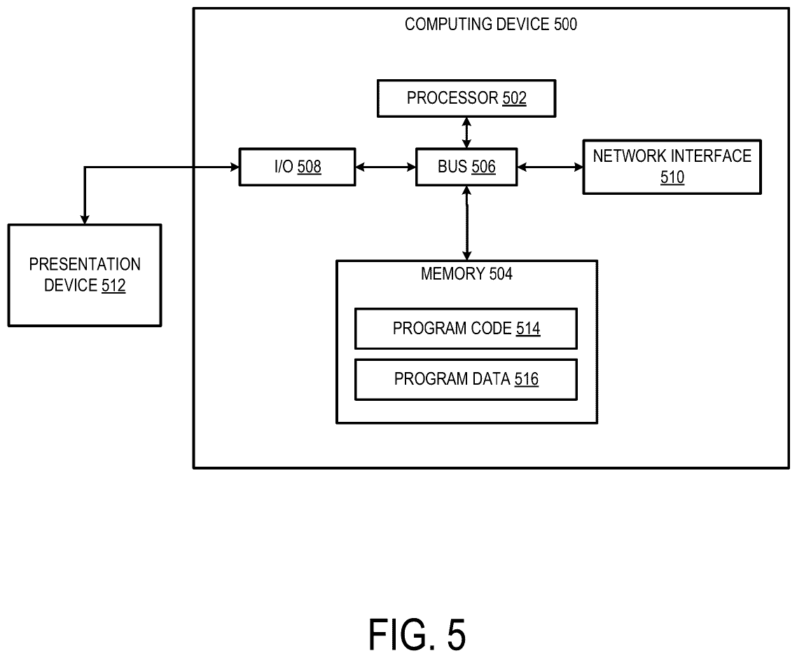

Any suitable computing system or group of computing systems can be used to perform the operations for the techniques described herein. For example, FIG. 5 is a block diagram depicting an example of a computing device 500, which can be used to implement the risk assessment server 104. The computing device 500 can include various devices for communicating with other devices in the computing environment 100, as described with respect to FIG. 1. The computing device 500 can include various devices for performing one or more operations, such as risk assessment operations, described above with respect to FIGS. 1-4.

The computing device 500 can include a processor 502 that can be communicatively coupled to a memory 504. The processor 502 can execute computer-executable program code stored in the memory 504, can access information stored in the memory 504, or a combination thereof. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 502 can include a microprocessor, an application-specific integrated circuit (ASIC), a field-programmable gate array (FPGA), or any other suitable processing device. The processor 502 can include any suitable number of processing devices, including one. The processor 502 can include or communicate with a memory 504. The memory 504 can store program code that, when executed by the processor 502, causes the processor 502 to perform the operations described herein.

The memory 504 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C#, Visual Basic, Java, Python, Perl, JavaScript, ActionScript, etc.

The computing device 500 may also include a number of external or internal devices such as input or output devices. For example, the computing device 500 is illustrated with an input/output interface 508 that can receive input from input devices or provide output to output devices. A bus 506 can also be included in the computing device 500. The bus 506 can communicatively couple one or more components of the computing device 500.

The computing device 500 can execute program code 514 that can include risk assessment application 106. The program code 514 for the risk assessment application 106 may be resident in any suitable computer-readable medium and may be executed on any suitable processing device. For example, and as illustrated in FIG. 5, the program code 514 for the risk assessment application 106 can reside in the memory 504 at the computing device 500 along with the program data 516 associated with the program code 514. Executing the risk assessment application 106 can configure the processor 502 to perform at least a portion of the operations described herein.

In some aspects, the computing device 500 can include one or more output devices. One example of an output device can be or include the network interface device 510 illustrated in FIG. 5. A network interface device 510 can include any device or group of devices suitable for establishing a wired or wireless data connection to one or more data networks described herein. Non-limiting examples of the network interface device 510 can include an Ethernet network adapter, a modem, etc.

Another example of an output device can include the presentation device 512 depicted in FIG. 5. A presentation device 512 can include any device or group of devices suitable for providing visual, auditory, or other suitable sensory output. Non-limiting examples of the presentation device 512 can include a touchscreen, a monitor, a speaker, a separate mobile computing device, etc. In some aspects, the presentation device 512 can include a remote client-computing device that communicates with the computing device 500 using one or more data networks described herein. In other aspects, the presentation device 512 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A system comprising:
a processor; and
a non-transitory computer-readable medium comprising instructions that are executable by the processor for causing the processor to perform operations comprising:
receiving a request for a risk indicator associated with a target entity, the request comprising a set of elements associated with an identity of the target entity, and each element of the set of elements associated with one or more risk attributes;
for each data source in a set of data sources:
retrieving identity data associated with the target entity based on the identity of the target entity; and
generating, based on the identity data and one or more attribute weights determinable for a set of attribute values for the one or more risk attributes, a set of element risk scores associated with each element of the set of elements to create a data source-level element risk score for each data source;
for each element in the set of elements, determining an aggregate element risk score by combining the data source-level element risk scores for the set of data sources, the aggregate element risk score based at least in part on a first set of data source weights associated with each respective data source;
determining the risk indicator by combining the aggregate element risk scores of the set of elements based on a first set of element weights, each element weight of the first set of element weights associated with each respective element of the set of elements; and
transmitting, to a remote computing device, a responsive message comprising at least the risk indicator usable to control access of the target entity to one or more interactive computing environments.

2. The system of claim 1, wherein the operation of generating a data source-level element risk score for an element comprises:
generating the set of attribute values for the one or more risk attributes associated with the element based on the identity data;
determining, for each of the one or more risk attributes associated with the element, an attribute weight that is included in the one or more attribute weights; and
based on the determination, generating the data source-level element risk score by combining the set of attribute values based on the attribute weight associated with each of the one or more risk attributes associated with the element.

3. The system of claim 1, wherein each aggregate element risk score represents a risk associated with the respective element based on the identity data.

4. The system of claim 1, wherein each element weight of the first set of element weights is determinable based on an amount that each element contributes to a change in an output of a machine-learning model, and wherein the output of the machine-learning model comprises the risk indicator.

5. The system of claim 1, wherein the operations further comprise normalizing each aggregated element risk score based on a number of data sources in the set of data sources and a number of types of data sources in the set of data sources.

6. The system of claim 1, wherein the first set of element weights comprises a subset of weights associated with the identity of the target entity, and wherein each weight of the subset of weights associated with the identity of the target entity is determinable based on an amount that the identity contributes the risk indicator based on a machine-learning model.

7. The system of claim 1, wherein the operations further comprise determining a trust indicator by combining the aggregate element risk score and an affiliation score for the target entity, wherein the trust indicator is usable in combination with the risk indicator to generate the responsive message.

8. A method comprising:
receiving a request for a risk indicator associated with a target entity, the request comprising a set of elements associated with an identity of the target entity, and each element associated with one or more risk attributes;
for each data source in a set of data sources:
retrieving identity data associated with the target entity based on the identity of the target entity; and
generating, based on the identity data and one or more attribute weights determined for a set of attribute values for the one or more risk attributes, a set of element risk scores associated with each element of the set of elements to create a data source-level element risk score for each data source;
for each element in the set of elements, determining an aggregate element risk score by combining the data source-level element risk scores for the set of data sources, the aggregate element risk score based at least in part on a first set of data source weights associated with each respective data source;
determining the risk indicator by combining the aggregate element risk scores of the set of elements based on a first set of element weights, each element weight of the first set of element weights associated with each respective element of the set of elements; and
transmitting, to a remote computing device, a responsive message comprising at least the risk indicator used to control access of the target entity to one or more interactive computing environments.

9. The method of claim 8, wherein generating a data source-level element risk score for an element comprises:
generating the set of attribute values for the one or more risk attributes associated with the element based on the identity data;
determining, for each of the one or more risk attributes associated with the element, an attribute weight that is included in the one or more attribute weights; and
based on the determination, generating the data source-level element risk score by combining the set of attribute values based on the attribute weight associated with each of the one or more risk attributes associated with the element.

10. The method of claim 8, wherein each aggregate element risk score represents a risk associated with the respective element based on the identity data.

11. The method of claim 8, wherein each element weight of the first set of element weights is determined based on an amount that each element contributes to a change in an output of a machine-learning model, and wherein the output of the machine-learning model comprises the risk indicator.

12. The method of claim 8, further comprising normalizing each aggregated element risk score based on a number of data sources in the set of data sources and a number of types of data sources in the set of data sources.

13. The method of claim 8, wherein the first set of element weights comprises a subset of weights associated with the identity of the target entity, and wherein each weight of the subset of weights associated with the identity of the target entity is determined based on an amount that the identity contributes the risk indicator based on a machine-learning model.

14. The method of claim 8, further comprising determining a trust indicator by combining the aggregate element risk score and an affiliation score for the target entity, wherein the trust indicator is used in combination with the risk indicator to generate the responsive message.

15. A non-transitory computer-readable storage medium having program code that is executable by a processor to cause a computing device to perform operations, the operations comprising:
receiving a request for a risk indicator associated with a target entity, the request comprising a set of elements associated with an identity of the target entity, and each element associated with one or more risk attributes;
for each data source in a set of data sources:
retrieving identity data associated with the target entity based on the identity of the target entity; and
generating, based on the identity data and one or more attribute weights determinable for a set of attribute values for the one or more risk attributes, a set of element risk scores associated with each element of the set of elements to create a data source-level element risk score for each data source;
for each element in the set of elements, determining an aggregate element risk score by combining the data source-level element risk scores for the set of data sources, the aggregate element risk score based at least in part on a first set of data source weights associated with each respective data source;
determining the risk indicator by combining the aggregate element risk scores of the set of elements based on a first set of element weights, each element weight of the first set of element weights associated with each respective element of the set of elements; and
transmitting, to a remote computing device, a responsive message comprising at least the risk indicator usable to control access of the target entity to one or more interactive computing environments.

16. The non-transitory computer-readable storage medium of claim 15, wherein the operation of generating a data source-level element risk score for an element comprises:
generating the set of attribute values for the one or more risk attributes associated with the element based on the identity data;
determining, for each of the one or more risk attributes associated with the element, an attribute weight that is included in the one or more attribute weights; and
based on the determination, generating the data source-level element risk score by combining the set of attribute values based on the attribute weight associated with each of the one or more risk attributes associated with the element.

17. The non-transitory computer-readable storage medium of claim 15, wherein each aggregate element risk score represents a risk associated with the respective element based on the identity data, and wherein each element weight of the first set of element weights is determinable based on an amount that each element contributes to the risk indicator based on a machine-learning model.

18. The non-transitory computer-readable storage medium of claim 15, wherein the operations further comprise normalizing each aggregated element risk score based on a number of data sources in the set of data sources and a number of types of data sources in the set of data sources.

19. The non-transitory computer-readable storage medium of claim 15, wherein the first set of element weights comprises a subset of weights associated with the identity of the target entity, and wherein each element weight of the first set of element weights is determinable based on an amount that each element contributes to a change in an output of a machine-learning model, and wherein the output of the machine-learning model comprises the risk indicator.

20. The non-transitory computer-readable storage medium of claim 15, wherein the operations further comprise determining a trust indicator by combining the aggregate element risk score and an affiliation score for the target entity, wherein the trust indicator is usable in combination with the risk indicator to generate the responsive message.
